(19) United States
(12) Patent Application Publication
(10) Pub. No.: US 2017/0351990 A1
(43) Pub. Date: Dec. 7, 2017

(54) SYSTEMS AND METHODS FOR IMPLEMENTING RELATIVE TAGS IN CONNECTION WITH USE OF AUTONOMOUS VEHICLES

(71) Applicant: GM Global Technology Operations LLC, Detroit, MI (US)

(72) Inventors: Ron M. Hecht, RA'ANANA (IL); Inbar Sela, HOD HaSHARON (IL); Claudia V. Goldman-Shenar, MEVASSERET ZION (IL); Gila Kamhi, ZICHRON YAAKOV (IL); Gaurav Talwar, NOVI, MI (US)

(21) Appl. No.: 15/604,605

(22) Filed: May 24, 2017

Related U.S. Application Data
(60) Provisional application No. 62/344,085, filed on Jun. 1, 2016.

(51) Int. Cl. G06Q 10/06; G06Q 50/00

(52) U.S. Cl. CPC G06Q 10/06316; G06Q 50/01; G06Q 2240/00

(57) ABSTRACT

A system for serving a shared-ride user, including a non-transitory storage component and a hardware-based processing unit performing module functions. The storage includes a user-input-interface module that receives, from a machine interface, user-input data regarding a user/co-passenger interaction. The storage includes a ride-sharing module determining, based on input data, an identity or account for the co-passenger, and an output module performing an action based on the identity or account. In another aspect, the storage includes a commerce module determining, based on the input data, a service or product indicated in the interaction and the output action is based on the service or product. In another aspect, the storage includes a social-media module accessing a social-media resource to, using the input data, determine an identity or account of the co-passenger, a product or service indicated by the co-passenger or the user in the interaction, or a schedule of the co-passenger.

### TECHNICAL FIELD

The present disclosure relates generally to vehicle ride sharing arrangements and, more particularly, to systems and processes for obtaining and delivering requested or desired information to customers of a shared autonomous vehicle, such as a taxi. The desired information obtained is generated based on relative-tag data indicating prior customer input, which is used as basis for a search for the requested or desired.

### BACKGROUND

This section provides background information related to the present disclosure which is not necessarily prior art.

Manufacturers are increasingly producing vehicles having higher levels of driving automation. Features such as adaptive cruise control and lateral positioning have become popular and are precursors to greater adoption of fully autonomous-driving-capable vehicles.

While availability of autonomous-driving-capable vehicles is on the rise, users' familiarity and comfort with autonomous-driving functions will not necessarily keep pace. User comfort with the automation is an important aspect in overall technology adoption and user experience.

Also, with highly automated vehicles expected to be commonplace in the near future, a market for fully-autonomous taxi services and shared vehicles is developing. In addition to becoming familiar with the automated functionality, customers interested in these services will need to become accustomed to be driven by a driverless vehicle that is not theirs, and in some cases along with other passengers, whom they may not know.

Uneasiness with automated-driving functionality, and possibly also with the shared-vehicle experience, can lead to reduced use of the autonomous driving capabilities, such as by the user not engaging, or disengaging, autonomous-driving operation, or not commencing or continuing in a shared-vehicle ride. In some cases, the user continues to use the autonomous functions, whether in a shared vehicle, but with a relatively low level of satisfaction.

An uncomfortable user may also be less likely to order the shared vehicle experience in the first place, or to learn about and use more-advanced autonomous-driving capabilities, whether in a shared ride or otherwise.

Levels of adoption can also affect marketing and sales of autonomous-driving-capable vehicles. As users' trust in autonomous-driving systems and shared-automated vehicles increases, the users are more likely to purchase an autonomous-driving-capable vehicle, schedule an automated taxi, share an automated vehicle, model doing the same for others, or expressly recommend that others do the same.

### SUMMARY

In one aspect, the present technology relates to a system for serving a user of a shared-ride service. The system includes a hardware-based processing unit, and a non-transitory computer-readable storage component. The storage component includes a user-input-interface module that, when executed by the hardware-based processing unit, receives, from a tangible machine-user interface, user-input data relating to a user/co-passenger interaction in a shared ride. The storage component also includes a ride-sharing module that, when executed by the hardware-based processing unit, determines, based on the user-input data, an identity or account for a co-passenger who shared the ride with the user; and an output module that performs an output action based on the identity or account determined.

In various embodiments, the shared ride is a present or past shared ride, and the output action includes scheduling a future shared ride including the user and the co-passenger.

In some cases, (i) the output module includes an external-communication module that, when executed by the processing unit, performs the output action including communicating with a remote destination based on the user-input data, and (ii) the external-communication module, when executed by the processing unit, communicates with the remote destination to inquire about, reserve, or purchase a product or service.

In various embodiments, the output module includes a customer-notification module that, when executed by the processing unit, initiates communicating a user-notification, for receipt by the user, including information relating to said interaction.

In implementations, the non-transitory computer-readable storage component includes a social-media module that is part of the ride-sharing module or in communication with the ride-sharing modules, to when executed by the hardware-based processing unit, obtain, from a social-media resource, social-media data relating to the interaction, for serving the user.

In various embodiments, (i) the non-transitory computer-readable storage component includes a commerce module that, when executed by the hardware-based processing unit, determines, using a commerce-related resource, commerce data related to the interaction, and (ii) the output action is based also on the commerce data.

In various embodiments, (i) the non-transitory computer-readable storage component includes a government-resources module that, when executed by the hardware-based processing unit, determines, using a government resource, government data related to the interaction; and (ii) the output action is based also on the government data.

In various embodiments, the shared-ride service includes an autonomous-vehicle shared-ride service, and the user-input-interface module, in receiving the user-input data regarding the user/co-passenger interaction, receives user-input data regarding a prior shared autonomous-vehicle ride.

The system includes the tangible machine-user interface, such as a vehicle microphone, touch screen, button, knob, keyboard, etc., or such interfaces of a portable device, such as user phone, which can also be, or be in communication with the system.

In various embodiments, the tangible machine-user interface is a component of an apparatus distinct from the system. The apparatus may be a portable user device.

In various embodiments, the user-input data includes a user request for information relating to the user/co-passenger interaction in the prior shared ride.

The non-transitory computer-readable storage component includes a tag-acquisition module that, when executed by the processing unit, determines one or more relative tags indicated by the user-input data.

The ride-sharing module may be configured to, when executed to determine the identity or account for the co-passenger, determine the identity or account based on the one or more relative tags determined.

In various embodiments, the non-transitory computer-readable storage component includes a tag-acquisition module that, when executed by the processing unit, determines one or more relative tags indicated by the user-input data.

The non-transitory computer-readable storage component in some cases includes at least one tag-using module selected from a group consisting of: (a) a social-media module, (b) a commerce module, and (c) a government-resources module, the tag-using module, when executed by the processing unit, determines tag-based results using the one or more relative tags; and the output action performed is based on the tag-based results.

In another aspect, the technology relates to a variation of the system for serving a user of a shared-ride service. The system includes the same hardware-based processing unit, and a non-transitory computer-readable storage component including (i) a user-input-interface module that, when executed by the hardware-based processing unit, receives, from a tangible machine-user interface, user-input data relating to a user/co-passenger interaction in a shared ride. The storage component also includes (ii) a commerce module that, when executed by the hardware-based processing unit, determines, based on the user-input data, a service or product indicated in the user/co-passenger interaction, and (iii) an output module that performs an output action based on the service or product determined.

In various embodiments, the output action includes recommending to the user, sending an inquiry about, reserving, ordering, or purchasing the service or product determined.

The commerce module in some cases, when executed by the hardware-based processing unit, determines the service or product based on co-passenger data indicating an identity or account of the co-passenger.

In various embodiments, the storage component comprises a social-media module that, when executed by the processing unit, communicates with a social-media resource to obtain social-media data relating to at least one of the interaction, service, and product.

In various embodiments, the storage component comprises a government-resources module that, when executed by the processing unit, communicates with a government resource to obtain government-resource data relating to at least one of the interaction, service, and/or product

In still another aspect, the technology also includes a system for serving a user of a shared-ride service. The system includes a hardware-based processing unit, and a non-transitory computer-readable storage component. The storage component includes (i) a user-input-interface module that, when executed by the hardware-based processing unit, receives, from a tangible machine-user interface, user-input data relating to a user/co-passenger interaction in a shared ride, (ii) a social-media module that, when executed by the hardware-based processing unit, accesses a social-media resource to, based on the user-input data, determine at least one of (a) an identity of the co-passenger; (b) an account of the co-passenger; (c) a product indicated by the co-passenger or the user in the interaction; (d) a service indicated by the co-passenger or the user in the interaction; and (e) a schedule of the co-passenger.

In still another aspect, the system is for providing information to a requesting-user of an autonomous-vehicle shared-ride or taxi service, or other shared-vehicle service. The system includes a hardware-based processing unit; and a non-transitory computer-readable storage component comprising various modules for performing the functions of the present technology.

The modules in various embodiments include a user-input-interface module that, when executed by the hardware-based processing unit, receives a user request regarding an interaction on a prior ride with another customer of the autonomous-vehicle shared-ride or taxi service providing at least one relative tag relating the interaction.

The modules include a ride-sharing module that, when executed by the hardware-based processing unit, determines an identity or account for the other customer based on the at least one relative tag provided by the user request.

And the modules include a customer-notification module that, when executed, communicates to the user the identity of the other customer.

In another aspect, the present technology relates to a system, for providing information to a requesting-user of an autonomous-vehicle shared-ride or taxi service, wherein the modules include the user-input-interface module, and the ride-sharing module that, when executed by the hardware-based processing unit, wherein the ride-sharing module determines an identity or account for the other customer based on the at least one relative tag provided by the user request, and schedules a future ride between the user and the other passenger in response to the user request and determining the identity. As described more below, relative tags are in various embodiments, used along the full experience, such as from making a reservation of a shared ride, in connection with the ride itself, and post ride. As an example—the vehicle may ask a rider post ride to “Please rate your experience with co-passenger Tim” or “Please rate your experience with the co-passenger next to you who listened to rock music.”

In still another aspect, the present technology relates to another system, for providing information to a requesting-user of an autonomous-vehicle shared-ride or taxi service, wherein the modules include the user-input-interface module, and a social-media or other activity module that, when executed by the processing unit, determines an identity or account for the other customer based on the at least one relative tag provided by the user request. The modules can again include the customer-notification module that, when executed, communicates to the user the identity of the other customer.

In yet another aspect, the present technology relates to another system, for providing information to a requesting-user of an autonomous-vehicle shared-ride or taxi service, wherein the modules include the user-input-interface module, and a commerce module that, when executed by the processing unit, determines a product or service based on the at least one relative tag provided by the user request. The modules can further include the customer-notification module that, when executed, communicates to the user an identity of the product or service.

In yet still other aspects, the present technology relates to a non-transitory computer-readable storage component according to any of the claims above, and to an algorithm for performing the functions claimed above or processes including the functions performed by the structure mentioned herein.

Other aspects of the present technology will be in part apparent and in part pointed out hereinafter.

### DESCRIPTION OF THE DRAWINGS

FIG. 1 illustrates schematically an example vehicle of transportation having a local computing device, and being in communication with a remote computing device, according to embodiments of the present technology.

FIG. 2 illustrates schematically more details of the example vehicle computing device of FIG. 1 in communication with the local and remote communication devices.

FIG. 3 illustrates schematically components of example personal portable computing devices.

FIG. 4 shows example code modules for one of the computing devices for performing functions of the present technology in conjunction with and external apparatus.

FIG. 5 shows algorithmic flows and processes involving the various components of FIG. 4.

FIG. 6 shows an example flow by ladder diagram, according to an implementation of the present technology.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or processes have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. TECHNOLOGY INTRODUCTION

The present disclosure describes, by various embodiments, systems and processes for generating, or otherwise obtaining, and delivering requested or desired information to customers of a shared autonomous vehicle service, such as an autonomous taxi. The information is generated based on, or includes, one or more components of information, which can be referred to as a relative tag or relative tags, and is indicative of customer input or needs. The tag is used as basis for a search for the requested or desired.

The system may be configured, for instance, to, if a user asks, “what is the concert mentioned by the guy I rode with this morning?” (being Jun. 1, 2016) generate or identify as relative tags any of the following terms (or item, groups, categories, flags, etc.): “concert,” “morning,” “this morning,” “Jun. 1, 2016,” “co-passenger,” or any suitable term or item for representing the user request.

Customers of shared autonomous vehicle services may ride with other passengers on occasion, and may not know those people before the ride. As an example, a customer may want to follow up to learn more about something discussed with a co-passenger with whom they recently shared a ride. They may want to learn more about an event that their co-passenger mentioned, or may want to inquire about whether the other person would like to meet and perhaps share a ride again. For instance, the customer may want to contact a passenger who has also opted into an information-share arrangement.

Systems are configured to determine information requested by the customer, or believed helpful for the customer, based on various factors. Example information includes input received from the co-passenger. In various embodiments, the information indicates the relative tag, comprising information that can be used as basis for a search for the requested or desired. The relative tag can include any of a wide variety of information that the system can use to determine the requested or helpful information. Examples tags include a date of a prior ride, a time of the prior ride, a first name of another passenger with whom the customer conversed, a venue mentioned by the other passenger, a name of an event mentioned by the other passenger, and a product or service mentioned by the other passenger.

With the relative tag, the system searches one of a wide variety of database or services, or other data sources, or resources, to determine the requested or deemed-helpful information. Example resources include and are not limited to social-media servers, other application servers, customer-service center computing systems, driver or rider databases, and product-, service-, or event-promoting web sites.

The customer interacts with one or more communication apparatus including or connected to the acting system. The communication apparatus may be able to obtain needed data on its own, or information from the communication apparatus can be used, by the communication apparatus or a device receiving communication-apparatus output, to obtain data from an external source, or resource, such as a database server, cloud system, or some other source having, or ‘tracking,’ the same tags.

The communication apparatus may include a user mobile device, such as a smartphone, tablet, or laptop, a user home computer, or a vehicle communication apparatus. The communication apparatus has any suitable user interface for receiving user input indicating the relative tag. The tag is used as basis for a search for the requested or desired, from at the apparatus or another source, as mentioned.

While select examples of the present technology describe transportation vehicles or modes of travel, and particularly automobiles, the technology is not limited by the focus. The concepts can be extended to a wide variety of systems and devices, such as other transportation or moving vehicles including aircraft, watercraft, trucks, busses, trains, trolleys, the like, and other.

And while select examples of the present technology describe autonomous vehicles, the technology is not limited to use in autonomous vehicles—fully or partially autonomous—or to times in which an autonomous-capable vehicle is being driven autonomously. A driver of a vehicle, whether autonomous, such as a taxi driver of a partially autonomous vehicle, can be considered a passenger in that the customer may obtain relative tag information from the driver.

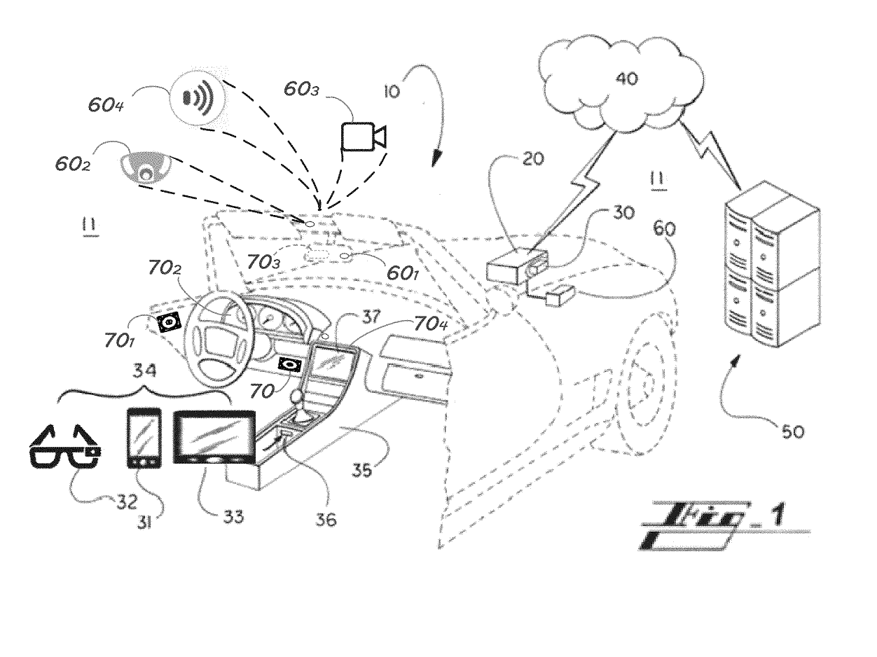

### II. HOST VEHICLE—FIG. 1

Turning now to the figures and more particularly to the first figure, FIG. 1 shows an example host structure or apparatus 10 in the form of a vehicle and, more particularly, an automobile.

The vehicle 10 includes a hardware-based controller or controller system 20. The hardware-based controller system 20 includes a communication sub-system 30 for communicating with potable or local computing devices 34 and/or external networks 40.

Example networks include the Internet, a local-area, cellular, or satellite network, vehicle-to-vehicle, pedestrian-to-vehicle or other infrastructure communications, etc. By the external networks 40, the vehicle 10 can reach mobile or local systems 34 or remote systems 50, such as remote servers.

Example local devices 34 include a user smartphone 31, a user-wearable device 32, such as the illustrated smart eye glasses, and a tablet 33, and are not limited to these examples. Other example wearables 32 include a smart watch, smart apparel, such as a shirt or belt, an accessory such as arm strap, or smart jewelry, such as earrings, necklaces, and lanyards.

Another example local device 34 is a user plug-in device, such as a USB mass storage device, or such a device configured to communicate wirelessly.

Still another example local device 34 is an on-board device (OBD) (not shown in detail), such as a wheel sensor, a brake sensor, an accelerometer, a rotor-wear sensor, throttle-position sensor, steering-angle sensor, revolutions-per-minute (RPM) indicator, brake-force sensors, other vehicle state or dynamics-related sensor for the vehicle, with which the vehicle is retrofitted with after manufacture. The OBD(s) can include or be a part of the sensor sub-system referenced below by numeral 60.

The vehicle controller system 20, which in contemplated embodiments includes one or more microcontrollers, can communicate with OBDs via a controller area network (CAN). The CAN message-based protocol is typically designed for multiplex electrical wiring with automobiles, and CAN infrastructure may include a CAN bus. The OBD can also be referred to as vehicle CAN interface (VCI) components or products, and the signals transferred by the CAN may be referred to as CAN signals. Communications between the OBD(s) and the primary controller or microcontroller 20 are in other embodiments executed via similar or other message-based protocol.

The vehicle 10 also has various mounting structures 35. The mounting structures 35 include a central console, a dashboard, and an instrument panel. The mounting structure 35 includes a plug-in port 36—a USB port, for instance—and a visual display 37, such as a touch-sensitive, input/output, human-machine interface (HMI).

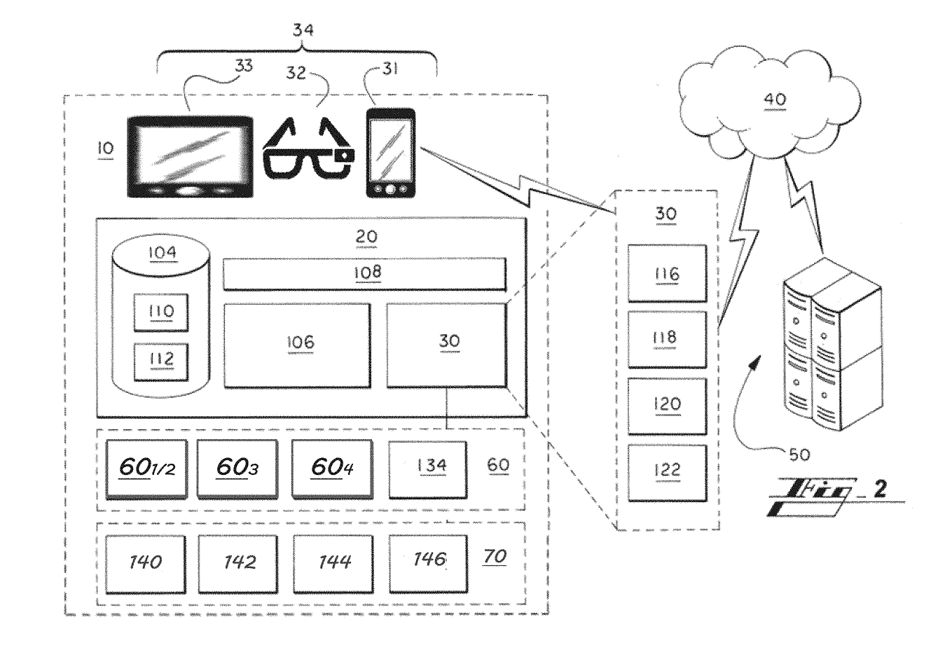

The vehicle 10 also has a sensor sub-system 60 including sensors providing information to the controller system 20. The sensor input to the controller 20 is shown schematically at the right, under the vehicle hood, of FIG. 2. Example sensors having base numeral 60 (60₁, 60₂, etc.) are also shown.

Sensor data relates to features such as vehicle operations, vehicle position, and vehicle pose, user characteristics, such as biometrics or physiological measures, and environmental-characteristics pertaining to a vehicle interior or outside of the vehicle 10.

Example sensors include a camera 60₁ positioned in a rear-view mirror of the vehicle 10, a dome or ceiling camera 60₂ positioned in a header of the vehicle 10, a world-facing camera 60₃ (facing away from vehicle 10), and a world-facing range sensor 60₄. Intra-vehicle-focused sensors 60₁, 60₂, such as cameras, and microphones, are configured to sense presence of people, activities or people, or other cabin activity or characteristics. The sensors can also be used for authentication purposes, in a registration or re-registration routine. This subset of sensors are described more below.

World-facing sensors 60₃, 60₄ sense characteristics about an environment 11 comprising, for instance, billboards, buildings, other vehicles, traffic signs, traffic lights, pedestrians, etc.

The OBDs mentioned can be considered as local devices, sensors of the sub-system 60, or both in various embodiments.

Local devices 34 (e.g., user phone, user wearable, or user plug-in device) can be considered as sensors 60 as well, such as in embodiments in which the vehicle 10 uses data provided by the local device based on output of a local-device sensor(s). The vehicle system can use data from a user smartphone, for instance, indicating user-physiological data sensed by a biometric sensor of the phone.

The vehicle 10 also includes cabin output components 70, such as audio speakers 70₁, and an instruments panel or display 70₂. The output components may also include dash or center-stack display screen 70₃, a rear-view-mirror screen 70₄ (for displaying imaging from a vehicle aft/backup camera), and any vehicle visual display device 37.

### III. ON-BOARD COMPUTING ARCHITECTURE—FIG. 2

FIG. 2 illustrates in more detail the hardware-based computing or controller system 20 of FIG. 1. The controller system 20 can be referred to by other terms, such as computing apparatus, controller, controller apparatus, or such descriptive term, and can be or include one or more microcontrollers, as referenced above.

The controller system 20 is in various embodiments part of the mentioned greater system 10, such as a vehicle.

The controller system 20 includes a hardware-based computer-readable storage medium, or data storage device 104 and a hardware-based processing unit 106. The processing unit 106 is connected or connectable to the computer-readable storage device 104 by way of a communication link 108, such as a computer bus or wireless components.

The processing unit 106 can be referenced by other names, such as processor, processing hardware unit, the like, or other.

The processing unit 106 can include or be multiple processors, which could include distributed processors or parallel processors in a single machine or multiple machines. The processing unit 106 can be used in supporting a virtual processing environment.

The processing unit 106 could include a state machine, application specific integrated circuit (ASIC), or a programmable gate array (PGA) including a Field PGA, for instance. References herein to the processing unit executing code or instructions to perform operations, acts, tasks, functions, steps, or the like, could include the processing unit performing the operations directly and/or facilitating, directing, or cooperating with another device or component to perform the operations.

In various embodiments, the data storage device 104 is any of a volatile medium, a non-volatile medium, a removable medium, and a non-removable medium.

The term computer-readable media and variants thereof, as used in the specification and claims, refer to tangible storage media. The storage can be referred to as a device, system, unit, the like, or other, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

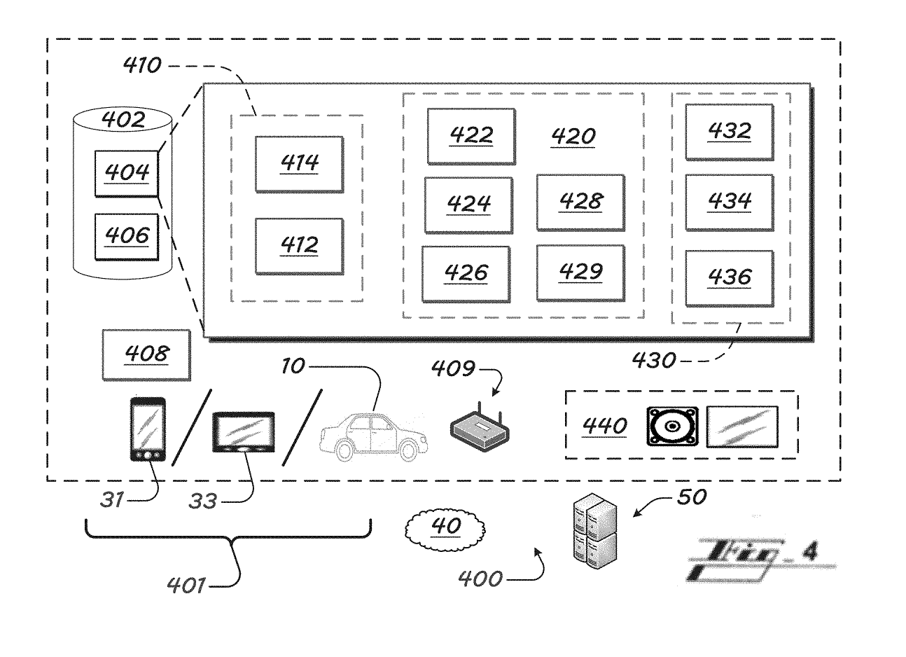

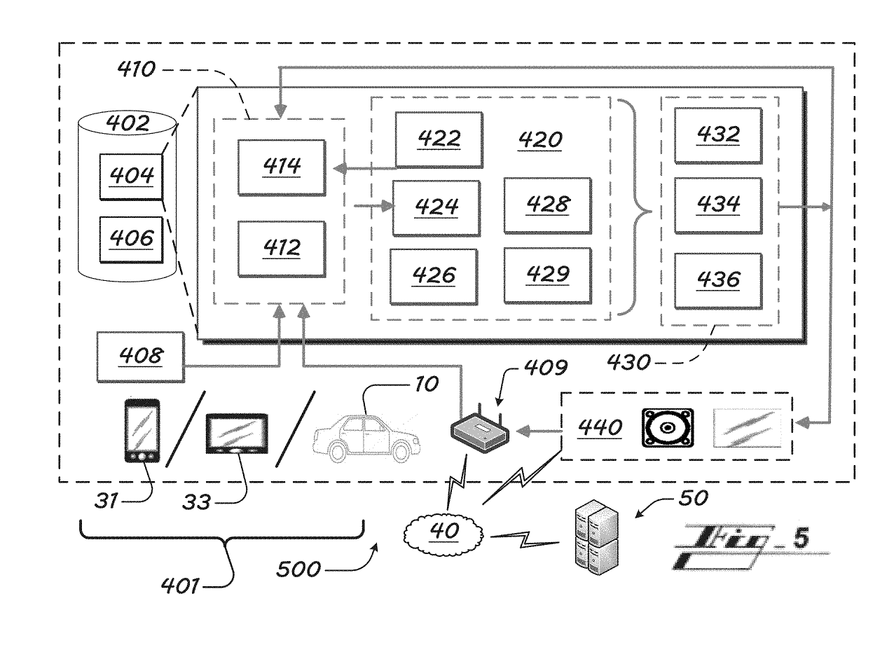

The data storage device 104 includes one or more storage or computing units or modules 110 storing computer-readable code or instructions executable by the processing unit 106 to perform the functions of the controller system 20 described herein. The modules and functions are described further below in connection with FIGS. 4 and 5.

The data storage device 104 in some embodiments also includes ancillary or supporting components 112, such as additional software and/or data supporting performance of the processes of the present disclosure, such as one or more user profiles or a group of default and/or user-set preferences.

As provided, the controller system 20 also includes a communication sub-system 30 for communicating with local and external devices and networks 34, 40, 50. The communication sub-system 30 in various embodiments includes any of a wire-based input/output (i/o) 116, at least one long-range wireless transceiver 118, and one or more short- and/or medium-range wireless transceivers 120. Component 122 is shown by way of example to emphasize that the system can be configured to accommodate one or more other types of wired or wireless communications.

The long-range transceiver 118 is in some embodiments configured to facilitate communications between the controller system 20 and a long-range network such as a satellite or a cellular telecommunications network, which can be considered also indicated schematically by reference numeral 40.

The short- or medium-range transceiver 120 is configured to facilitate short- or medium-range communications, such as communications with other vehicles, in vehicle-to-vehicle (V2V) communications, and communications with transportation system infrastructure (V2I). Broadly, vehicle-to-entity (V2X) can refer to short-range communications with any type of external entity (for example, devices associated with pedestrians or cyclists, etc.).

To communicate V2V, V2I, or with other extra-vehicle devices, such as local communication routers, etc., the short- or medium-range communication transceiver 120 may be configured to communicate by way of one or more short- or medium-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

By short-, medium-, and/or long-range wireless communications, the controller system 20 can, by operation of the processor 106, send and receive information, such as in the form of messages or packetized data, to and from the communication network(s) 40.

Remote devices 50 with which the sub-system 30 communicates are in various embodiments nearby the vehicle 10, remote to the vehicle, or both.

The remote devices 50 can be configured with any suitable structure for performing the operations described herein. Example structure includes any or all structures like those described in connection with the vehicle computing device 20. A remote device 50 includes, for instance, a processing unit, a storage medium comprising modules, a communication bus, and an input/output communication structure. These features are considered shown for the remote device 50 by FIG. 1 and the cross-reference provided by this paragraph.

While local devices 34 are shown within the vehicle 10 in FIGS. 1 and 2, any of them may be external to, and in communication with, the vehicle.

Example remote systems 50 include a remote server, such as an application server. Another example remote system 50 includes a remote control center, data, center or customer-service center.

The user computing or electronic device 34, such as a smartphone, can also be remote to the vehicle 10, and in communication with the sub-system 30, such as by way of the Internet or another communication network 40.

An example control center is the OnStar® control center, having facilities for interacting with vehicles and users, whether by way of the vehicle or otherwise (for example, mobile phone) by way of long-range communications, such as satellite or cellular communications. ONSTAR is a registered trademark of the OnStar Corporation, which is a subsidiary of the General Motors Company.

As mentioned, the vehicle 10 also includes a sensor sub-system 60 comprising sensors providing information to the controller system 20 regarding items such as vehicle operations, vehicle position, vehicle pose, user characteristics, such as biometrics or physiological measures, and/or the environment about the vehicle 10. The arrangement can be configured so that the controller system 20 communicates with, or at least receives signals from sensors of the sensor sub-system 60, via wired or short-range wireless communication links 116, 120.

In various embodiments, the sensor sub-system 60 includes at least one camera and at least one range sensor 60₄, such as radar or sonar, directed away from the vehicle, such as for supporting autonomous driving.

Visual-light cameras 60₃ directed away from the vehicle 10 may include a monocular forward-looking camera, such as those used in lane-departure-warning (LDW) systems. Embodiments may include other camera technologies, such as a stereo camera or a trifocal camera.

Sensors configured to sense external conditions may be arranged or oriented in any of a variety of directions without departing from the scope of the present disclosure. For example, the cameras 60₃ and the range sensor 60₄ may be oriented at each, or a select, position of, (i) facing forward from a front center point of the vehicle 10, (ii) facing rearward from a rear center point of the vehicle 10, (iii) facing laterally of the vehicle from a side position of the vehicle 10, and/or (iv) between these directions, and each at or toward any elevation, for example.

The range sensor 60₄ may include a short-range radar (SRR), an ultrasonic sensor, a long-range radar, such as those used in autonomous or adaptive-cruise-control (ACC) systems, sonar, or a Light Detection And Ranging (LiDAR) sensor, for example.

Other example sensor sub-systems 60 include the mentioned cabin sensors (60₁, 60₂, etc.) configured and arranged (e.g., positioned and fitted in the vehicle) to sense activity, people, cabin environmental conditions, or other features relating to the interior of the vehicle. Example cabin sensors (60₁, 60₂, etc.) include microphones, in-vehicle visual-light cameras, seat-weight sensors, user salinity, retina or other user characteristics, biometrics, or physiological measures, and/or the environment about the vehicle 10.

The cabin sensors (60₁, 60₂, etc.), of the vehicle sensors 60, may include one or more temperature-sensitive cameras (e.g., visual-light-based (3D, RGB, RGB-D), infra-red or thermographic) or sensors. In various embodiments, cameras are positioned preferably at a high position in the vehicle 10. Example positions include on a rear-view mirror and in a ceiling compartment.

A higher positioning reduces interference from lateral obstacles, such as front-row seat backs blocking second- or third-row passengers, or blocking more of those passengers. A higher positioned camera (light-based (e.g., RGB, RGB-D, 3D, or thermal or infra-red) or other sensor will likely be able to sense temperature of more of each passenger's body—e.g., torso, legs, feet.

Two example locations for the camera(s) are indicated in FIG. 1 by reference numeral 60₁, 60₂, etc.—on at rear-view mirror and one at the vehicle header.

Other example sensor sub-systems 60 include dynamic vehicle sensors 134, such as an inertial-momentum unit (IMU), having one or more accelerometers, a wheel sensor, or a sensor associated with a steering system (for example, steering wheel) of the vehicle 10.

The sensors 60 can include any sensor for measuring a vehicle pose or other dynamics, such as position, speed, acceleration, or height—e.g., vehicle height sensor.

The sensors 60 can include any sensor for measuring an environment of the vehicle, including those mentioned above, and others such as a precipitation sensor for detecting whether and how much it is raining or snowing, a temperature sensor, and any other.

Sensors for sensing user characteristics include any biometric or physiological sensor, such as a camera used for retina or other eye-feature recognition, facial recognition, or fingerprint recognition, a thermal sensor, a microphone used for voice or other user recognition, other types of user-identifying camera-based systems, a weight sensor, breath-quality sensors (e.g., breathalyzer), a user-temperature sensor, electrocardiogram (ECG) sensor, Electrodermal Activity (EDA) or Galvanic Skin Response (GSR) sensors, Blood Volume Pulse (BVP) sensors, Heart Rate (HR) sensors, electroencephalogram (EEG) sensor, Electromyography (EMG), and user-temperature, a sensor measuring salinity level, the like, or other.

User-vehicle interfaces, such as a touch-sensitive display 37, buttons, knobs, the like, or other can also be considered part of the sensor sub-system 60.

FIG. 2 also shows the cabin output components 70 mentioned above. The output components in various embodiments include a mechanism for communicating with vehicle occupants. The components include but are not limited to audio speakers 140, visual displays 142, such as the instruments panel, center-stack display screen, and rear-view-mirror screen, and haptic outputs 144, such as steering wheel or seat vibration actuators. The fourth element 146 in this section 70 is provided to emphasize that the vehicle can include any of a wide variety of other in output components, such as components providing an aroma or light into the cabin.

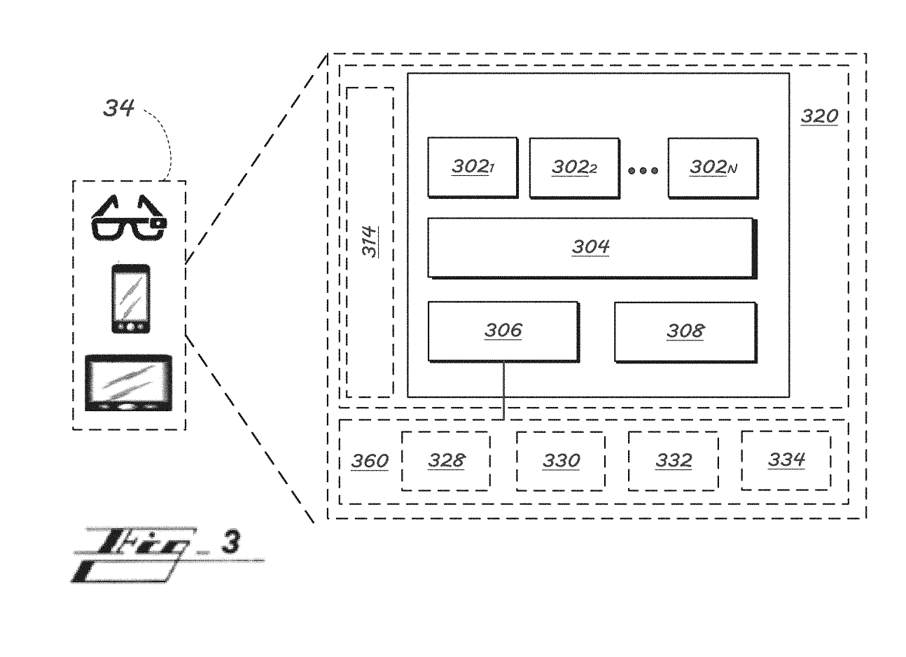

### IV. EXAMPLE LOCAL DEVICE 34—FIG. 3

FIG. 3 illustrates components of a portable device 34 of FIGS. 1 and 2, schematically.

The portable device 34 can be referred to by other terms, such as a driver device, a local device, an add-on device, a user-mobile device, a personal device, a plug-in device, an ancillary device, system, or apparatus. The term portable device 34 is used primarily herein because the device 34 is not an original part of the system(s), such as the vehicle 10, with which the device 34 is used. Though referred to as portable primarily herein, the portable device 34 is not limited in every embodiment to being a portable or mobile device. The device 34 may be a smart phone, tablet, or laptop. The device 34 can be a desktop computer, or any computing device.

The portable devices 34 are configured with any suitable structure for performing the operations described for them. Example structure includes any of the structures described herein in connection with the vehicle computing device 20, such as (i) output components—e.g., screens, speakers, (ii) a hardware-based computer-readable storage medium, or data storage device, like the device 104 of FIG. 2, and a (iii) hardware-based processing unit (like the unit 106 of FIG. 2).

The data storage device of the portable device 34 can include one or more storage or code modules storing computer-readable code or instructions executable by the processing unit of the portable device to perform the functions of the hardware-based controlling apparatus described herein, or other functions described herein. The data storage of the portable device in various embodiments also includes ancillary or supporting components, like those 112 of FIG. 2, such as additional software and/or data supporting performance of the processes of the present disclosure, such as one or more driver profiles or a group of default and/or driver-set preferences. The code modules supporting components are in various embodiments components of, or accessible to, one or more portable-device programs, such as the applications 302 described next.

With reference to FIG. 3, for instance, the portable device 34 includes a device computing system 320 having, along with any analogous features as those shown in FIG. 1 for the vehicle computing system 20:
applications 302₁, 302₂, . . . 302_{N};
an operating system, processing unit, and device drivers, indicated collectively for simplicity by reference numeral 304;
an input/output component 306 for communicating with local sensors (microphone, cameras, etc.), peripherals, and apparatus beyond the device computing system 320, and external devices, such as by including one or more short-, medium-, or long-range transceiver configured to communicate by way of any communication protocols—example protocols include Dedicated Short-Range Communications (DSRC), WI-FI®, BLUETOOTH®, infrared, infrared data association (IRDA), near field communications (NFC), the like, or improvements thereof; and
a device-locating component 308, such as one or more of a GPS receiver, components using multilateration, trilateration, or triangulation, or any component suitable for determining a form of device location (coordinates, proximity, or other) or for providing or supporting location-based services.

The portable device 34 in various embodiments includes any of various respective sensor sub-systems 360. Example sensors are indicated by reference numerals 328, 330, 332, 334.

In various embodiments, the sensor sub-system 360 includes a user-facing and a world-facing camera, both being indicated schematically by reference numeral 328, and a microphone 330. The device(s) 34 can include any available sub-systems for processing input from sensors including the cameras and microphone, such as voice or facial recognition, retina scanning technology for identification, voice-to-text processing, the like, or other.

In various embodiments, the sensor include an inertial-momentum unit (IMU) 332, such as one having one or more accelerometers.

A fourth symbol 334 is provided in the sensor group 360 to indicate expressly that the group 360 can include one or more of a wide variety of sensors for performing the functions described herein.

### V. SELECT STRUCTURE OF ACTING APPARATUS—FIG. 4

FIG. 4 shows an arrangement 400 including an acting apparatus 401, configured to perform functions of the present technology.

While one apparatus is shown, the functions can be performed by one or more apparatus.

Example acting apparatus 401 include a portable device 34 or the vehicle 10. The vehicle can be any vehicle that the customer is using, whether they own it. The vehicle may as mentioned be an autonomous-driving vehicle that two customers shared a ride in.

Other example acting apparatus 401 include a remote server or computing system 50, such as a system of a customer-service center, like the OnStar® control center.

The arrangement 400 includes example memory components. As mentioned, the data storage device 402—such as the storage of the vehicle, portable computing systems, or remote systems 20, 34, 50—includes one or more modules 404, like the vehicle modules 110 in FIG. 2. The modules are configured to perform the processes of the present disclosure.

The modules 404 can be a part of or include one or more programs or applications of the acting apparatus 401, such as the applications 302 of the portable device 34 in FIG. 3.

The modules 404 can include or be in communication with a local and/or remote version(s) of a social media application or a reservation application. Any such application is in various embodiments configured to receive user inquiry for information, such as regarding a co-passenger.

As an example, the system may receive via portable device or vehicle HMI, a user request about a recent co-passenger or regarding interactions with the co-passengers, such as, “Can you give me the name of the doctor that my co-passenger mentioned yesterday afternoon?” or “Can you connect me to [e.g., initiate a call] to the doctor that my co-passenger mentioned yesterday afternoon?”

The application is further configured to perform various other operations, including any of: (i) generating or otherwise obtaining reply information, for responding to the inquiry, for sharing with the inquiring user, (ii) arranging services such as reserving a future autonomous-vehicle ride, (iii) arranging the user to attend an event or venue, such as a restaurant or concert, or other service. The latter two functions may be performed by, or using, a reservation application of the portable device apps 302, for instance.

The apparatus 401 include ancillary components 406 in various embodiments, like the components indicated by reference numeral 112 in connection with FIG. 2. Example ancillary components include additional software and/or data supporting performance of the processes of the present disclosure. The ancillary components 406 can include, for example, additional software and/or data supporting performance of the processes of the present disclosure, such as one or more driver profiles or a group of default and/or driver-set preferences.

Any of the code or instructions described can be part of more than one module 404. And any functions described herein can be performed by execution of instructions in one or more modules, though the functions may be described primarily in connection with one module by way of primary example. Each of the modules 404 can be referred to by any of a variety of names, such as by a term or phrase indicative of its function.

Sub-modules can cause the hardware-based processing unit—the processing unit 106 of FIG. 2, for instance—to perform specific sub-operations or routines supporting module functions. Each sub-module can be referred to by any of a variety of names, such as by a term or phrase indicative of its function.

Modules 404 can be divided into the following groups and include the following example modules:
Input Group 410
   an input-interface module, or user-input-interface module 412; and
   a database module 414;
Activity Group 420
   a ride-sharing module 422;
   a social-media module 424;
   commerce module 426;
   government-resources module 428; and
   other-resource module(s) 429;
Output Group 430
   customer-notification module 432;
   data-storage module 434; and
   external-communications module 436.

Other components shown in FIG. 4 include an intra-apparatus communication interface 408, such as data or signal inputs from an apparatus microphone, keypad or other HMI by which a customer has provided a request or other input indicating a relevant, searchable tag, or other relevant, usable information, such as GPS location.

The components of FIG. 4 also include an extra-apparatus communication interface 409 for communicating with remote or other external apparatus, such as a remote server 50, or a local, but external (e.g., not part of the vehicle) portable device 34. Example remote apparatus include computers of a driver of an authority (parent, work supervisor, police), vehicle-operator servers, customer-control center system, such as systems of the OnStar® control center mentioned, or a vehicle-operator system, such as that of a taxi company operating a fleet of which the vehicle 10 belongs, or of an operator of a ride-sharing service.

The view also shows example apparatus outputs 440, including and are not limited to:
audio-output component, such as vehicle or portable-device speakers;
visual-output component, such as vehicle or portable-device screens;
the external-device communication component 409 or link to the communication component 409, for communicating with any of a variety of apparatus and devices, such as for providing alerts information to computing apparatus of relevant entities such as authorities, first responders, parents, an operator or owner of a subject vehicle 10, or a customer-service center system, such as of the OnStar® control center.

The modules, sub-modules, and their functions are described more below.

### VI. ALGORITHMS AND PROCESSES—FIG. 5

### VI.A. Introduction to the Processes

FIG. 5 shows an example algorithm, process, or routine represented schematically by a flow 500, according to embodiments of the present technology. The flow is at times referred to as a process or method herein for simplicity.

Though a single process 500 is shown for simplicity, any of the functions or operations can be performed in one or more or processes, routines, or sub-routines of one or more algorithms, by one or more devices or systems.

It should be understood that steps, operations, or functions of the processes are not necessarily presented in any particular order and that performance of some or all the operations in an alternative order is possible and is contemplated. The processes can also be combined or overlap, such as one or more operations of one of the processes being performed in the other process.

The operations have been presented in the demonstrated order for ease of description and illustration. Operations can be added, omitted and/or performed simultaneously without departing from the scope of the appended claims. It should also be understood that the illustrated processes can be ended at any time.

In certain embodiments, some or all operations of the processes and/or substantially equivalent operations are performed by a computer processor, such as the hardware-based processing units mentioned (e.g., unit 106 of the vehicle 10 in FIG. 2) or user-device 34 equivalent, executing computer-executable instructions stored on a non-transitory computer-readable storage device 402 of the respective apparatus.

### VI.B. System Components and Functions

FIG. 5 shows the components of FIG. 4 interacting according to various exemplary algorithms and process flows.

The input group 410 includes the input-interface module 412 and the database module 414. Input group modules interacts with each other in various ways to accomplish the functions of the present technology.

In a contemplated embodiment the group 410 includes a learning module. The learning module is described more below.

The input interface module 412, executed by a processor such as the hardware-based processing unit 106 of the vehicle 10, receives any of a wide variety of input data or signals, including from the sources described in the previous section (V.).

The database module 414, in various embodiments, stores data received, generated, pre-collected, or pre-generated regarding the driver. The data can be stored in a driver profile. The driver profile can be part of, or accessible by, one or more relevant applications, such as the applications 302 of FIG. 3.

Inputs include customer inputs requesting information, or customer inputs indicating information that would be helpful to the customer.

Customers of autonomous shared-or-taxi-vehicle services may ride with others passengers on occasion, and may not know those people before the ride. The service can include multiple vehicles over time, such as a fleet of taxis or various share-a-ride vehicles. As an example, a customer may want to follow up on something discussed with a passenger they rode with on a prior day, such as by wanting to obtain information regarding something mentioned by or discussed with the co-passenger(s), arrange a subsequent vehicle ride to a venue or event mentioned by a passenger they recently met. Or a customer may want to contact a passenger who has also opted into an information-share arrangement.

Systems are configured to determine information requested by, or believed helpful for, the customer base on user input indicating the relative tag, comprising information that can be searched. The relative tag can include any of a wide variety of information that the system can use to determine the requested or helpful information. Examples tag or information containing tags include and are far from limited to a date of a prior ride, a time of a prior ride, a first name of another passenger with whom the customer conversed, a venue mentioned by the other passenger, an event mentioned by the other passenger, and a product or service mentioned by the other passenger.

With the relative tag, the system searches one or more of a wide variety of database or services, or other data sources to determine the requested or helpful information.

The customer interacts with one or more communication apparatus including or connected to the acting system. The apparatus can include, for instance, a portable device, such as a user smartphone, tablet, an add-on, after-market, device to the vehicle, or laptop, a user home computer, or a vehicle communication apparatus, having any suitable user interfaces for receiving user input indicating the relative, searchable tag (e.g., information with which helpful searches can be made), and for returning results to the customer.

Relative tag information, or information indicating a tag, can be stored to the apparatus memory 402 via the database module 414. Modules of the activity group 420 process data from the input interface module 412 or the storage module 414, and output of the activity module 420 is provided to the output group 430. Output of the activity module 420 can also be provided to the storage module 414 for use in subsequent operations of the input, activity, and/or output groups 430.

The activity group 420 includes the ride-sharing module 422, the social-media module 424, the commerce module 426, the government-resources module 428, and possibly one or more other-resource module(s) 429.

In various embodiments, the ride-sharing module 422 is configured to cause the processing unit to, based on user input received from the input-interface module 412, generate, identify, procure, or otherwise determine or obtain one or more relative tags to use in searching for information for responding to a user request, or determined information for providing to the user in response to a statement or action of the user. In various embodiments, the function is performed by a tag-acquisition module (or sub-module), which may be a part of the ride-sharing module 422, the input-interface module 412, or another component of the system code 404 of the storage device 402.

In an above-mentioned example, the ride-sharing module 422, input-interface module 412, or such tag-acquisition module, may be configured to, if a user asks, “what is the concert mentioned by the guy I rode with this morning?” (being Jun. 1, 2016) generate or identify as relative tags any of the following terms (or item, groups, categories, flags, etc.): “concert,” “morning,” “this morning,” “Jun. 1, 2016,” “co-passenger,” or any suitable term or item for representing the user request.

In a contemplated embodiment the group 420 includes a learning module. The learning module is described more below.

The other-resource module, or any other module, may also process context information, such as locations of the shared vehicle when the user and the co-passenger shared a ride—e.g., origin, destination, waypoints, or any route location(s). The other-resource module(s) can include a navigation or map-database module, as just a couple of examples, allowing the system to generate or obtain locations and directions for routing as may be needed to service customer requests or apparent needs.

The ride-sharing module 422, when executed by the associated processing hardware unit, can perform any of a wide variety of functions relating to the interaction that a requesting user of the autonomous ride-sharing or taxi service had with another passenger of the service. The ride-sharing module 422 stores, or has access to, such as via the database module 414 or a remote server 50, information indicating all of the people who used the service for a ride and when.

If a requesting user asks the system, via a vehicle or portable device HMI, for instance, about something stemming from an interaction with a co-passenger with whom the user shared a ride with recently, the system, can determine who the co-passenger being referred to is. In this case, user input indicating the day of the subject ride is an example relative, searchable tag that the system can use to obtain the co-passenger identity. Identity of the requesting user can be considered another tag used in this scenario by the system to obtain the information requested. The system can perform the task using the ride-sharing module 422, which can include, be, or use a customized application, such as that indicated by reference numeral 302₁ in FIG. 3.

Sometimes, all of the data, that the ride-sharing module 422 needs for determining information to send to a user, is not available. In some embodiments, the module 422 is configured to in such situations further interact with the user, who may be requesting the information, or otherwise function to obtain the information needed.

As an example, if the system receives a request from a user indicating that they wish to contact a co-passenger from a ride about a month ago, and both the user and the subject co-passenger have shared many rides on various days in that timeframe, the module 422 cannot determine which co-passenger is being identified based on only the relative tag indicating that the subject ride was about a month ago. The user may provide as further relative tag, whether in response to system prompt for same, more information about the subject ride about a month ago or the subject co-passenger, such as where the subject ride was from or to, or a career of, or demographics (gender, apparent age, apparent height, etc.) about, the other passenger—e.g., “he said she was an accountant.”

The system is programmed in various embodiments to appreciate that user's tend or like to refer to others in relative manners, and may not have detailed information. A user comment may refer to “the lady I rode with yesterday,” or “the tall guy with brown hair’ that I rode with last week, for instance.

As referenced, the system can be configured to initiate some dialogue to obtain more details—e.g., “are you referring to you morning ride to Staten Island on the Saturday before Memorial Day?”

The activity group modules 420 can search any of a wide variety of databases, web sites, apps, servers, or other resources to obtain information requested by the customer or indicated by information provided by the customer. Some are particular to the co-passenger with whom the requesting customer was interacting, and some not.

For instance, if the co-passenger mentioned the name an upcoming festival in a local park, the system can obtain information about the festival without needing to access any information about the co-passenger.

If the co-passenger mentioned an event in a more-vague manner, however, the system may need, with appropriate permissions in place, access information regarding the co-passenger, such as a social-media site, to determine which festival they were likely referring to in the conversation with the user.

Example sources include and are not limited to social media servers, other application servers, customer-service center computing systems, driver or rider databases, and product-, service-, or event-promoting web sites.

For some data searches or arranging of services for a customer, where privacy is not an issue, other-passenger approval is not needed. For instance, if a customer requests information about a concert that another passenger mentioned, the system—e.g., the social-media or other module 424, 429 can obtain and provide to the requesting customer information about the concert, so long as the information is not obtained from private or proprietary source, such as a log-in, password protected source, like a subject customer social-media site of the prior co-passenger, without permission of the subject prior co-passenger. The information obtained can be used to advise the requesting customer of a concert time, location, and other details about the concert. The system could also, based on the customer request or system programming otherwise, arrange reservation(s) to the concert and/or a ride using the vehicle 10 or a shared or taxis service for the customer to attend the concert.

As another example of the system being able to obtain information or arranging services for the customer without need for other-passenger approval, if the customer asked the system about a product or service that was mentioned by a co-passenger, the system could obtain information about the product or services (using the commerce module 426, for example) for the customer, recommend a product or service, and/or arrange inquiry, reservation, or purchase for the customer of the subject product or service.

In various embodiments, some information or services for the customer can be obtained and provided only if appropriate authorization, pre-approval, or the like is already in place. As examples, passengers of an autonomous ride-sharing or taxi service can have the option of allowing, or opting in to allow, other passengers to receive personal information about them, access to social-media accounts of the passenger. The system is in some embodiments configured to allow customers to, if they wish, provide such pre-approval at only select levels or for certain types of information sharing with other customers of the autonomous ride-sharing or taxi service.

A user can for instance, provide approval to the system to allow the system to search its social-media site for non-personal identifying information, such as location and time of an upcoming concert they are planning to attend, as discussed in the in-vehicle discussion with the requesting customer, and as referenced in the social-media site.

In a contemplated embodiment, a user can authorize the system to initiate an anonymous communication between a requesting customer of the autonomous ride-sharing or taxi service and the user of the same service, whereby the system, or a server, sends a message from the requesting customer to an address of the user without the requesting customer being able to see the actual address of the user. Either person can provide personal contact information from there if they wish.

In another contemplated embodiment, the system can provide a request to a user, such as via text, email, or app notice (on user mobile device, for instance), when a requesting customer is seeking (i) contact with the user, (ii) personal contact information (e.g., email address or mobile phone number for text), (iii) information for which the system would need to access a personal account of the user, or (iv) the like. The setting can again be set to levels, so that the user pre-authorizes the system to provide certain types of information without further approval from the user being needed, and would need to obtain further user approval for other types of information.

Regarding the government-resources module 428, the module 428 can in various embodiments perform any of a wide variety of functions relating to government resources.

As an example, the module 428 can, based on government-published information, confirm identity of another passenger or provide contact information. The function is in implementations performed so long as, or to the extent that, the information is not private or proprietary or the user provided pre-approval to the system to obtain and share the information. An example government source is a public state drivers-license database, or a public registered-voters database.

The system may be configured with various types of arrangements whereby a user can approve sharing levels regarding information about them, and the arrangements may also relate their approval to an ability of the user to obtain information regarding others. The system may be configured, for instance, to allow a user to approve at least a low level of sharing in exchange for being able to themselves request and receive similar information or service in connection with prior exchanges that they have had with co-passengers. Or to allow the user to select a higher-level approval in exchange for the right to obtain more information about fellow co-passengers.

Many users may value the social, sharing, and useful functions of the system, including for others, even over certain privacies for themselves. The system may be configured to allow a user to approve little or no limits on sharing of readily-accessible information about them (e.g., social media handle, concert going to next week), and in some embodiments to allow such whether they are awarded related privileged for accessing information regarding encounters with other passengers.

A user may already have no limits set in the system regarding who can access a certain social-media page, for instance, and so authorize the system to obtain and share any information available there. Or, with the page being public, the system in some cases can obtain the open information without need for any pre-approval form the user.

Output of the activity module 420 is in various embodiments provided to any of the database module 414 and at least one module of the output group 430. Functions of the output group can include formatting, converting, or otherwise processing output of the activity group 420 prior to delivering same to the various output components or along various output channels of communication.

The output group 430 includes the customer-notification module 432, the data-storage module 434, and the external-communications module 436.

The customer-notification module 432, when executed by the processing unit, communicates, for receipt by a requesting customer, information generated or obtained at the activity group 420. The module 432 can deliver the information by any suitable route, such as via an apparatus output 440, such as via a display interface of a dedicated application on a portable, a device or vehicle speaker, a message sent to a user address, such as email or phone, the like, or other communication mechanism or channel.

Information generated or obtained at the activity group 420, or generated or obtained at the output group 430, can be stored at the apparatus and/or another apparatus (e.g., remote server 50) for use in later operations of the system.

The storing functions can be performed via the data-storage module 434.

The external-communications module 436 is configured to facilitate any needed external communications. As just a few examples, the functions of the external-communications module 436 can include arranging communications with others, such as a subject prior co-passenger, a restaurant for making reservations, the like or other.

As referenced above, including in connection with the input and activity groups 410, 420, the system could be configured to learn preferences or tendencies of a customer of the autonomous ride-sharing or taxi service. The information can be stored at a user profile, for instance, as referenced above.

The system can be configured for such learning functions in various ways, including by including a learning module, which can be a part of the input and/or the activity modules 410, 420. The learning module in various embodiments can be configured to include artificial intelligence, computational intelligence, neural-network, or heuristic structures, or the like, for performing the functions related to learning about the user and implementing results for providing improved subsequent service.

### VII. ADDITIONAL STRUCTURE, ALGORITHM FEATURES, AND OPERATIONS

With or in addition to any of the other embodiments described herein, the present technology can include any of the following structure or functions:
i. The technology in various embodiments includes a system and method for enhancing speech interaction by extracting autonomous ride sharing user's relative information.
ii. As an example, the operations can include arranging, for a requesting customer, a future ride or interactions with another, prior co-passenger, whom the requesting customer does not know personally—e.g., does not have sufficient information, such as contact information, about. The system is configured to extract any one or more of a wide variety of relative tags based on input from the requesting user and use the tags to obtain requested information, such as from sources such as: social media (identifying events or products of interest to a subject prior co-passenger, for instance), vehicle-ride history, shared-rides history, or personalized reservation app including individual and social preferences.
iii. In contemplated embodiments, the system obtains, for an autonomous shared-ride user, information that is not expressly requested by the service user, or the system can prompt the search for relevant information. The system may be configured to sense the user saying that they enjoyed a talk with a co-passenger earlier in the day, or that the user would like more information regarding the talk, and configured to propose to the user that the system help them contact the co-passenger, or to recommend or order desired information, product, or services.

The following use cases further illustrate aspects of the present technology that can be implemented with or in addition to any of the other embodiments described herein.

### Use Case #1—

### Scheduling a Shared Ride Based on Relative Data:

Scott is ride sharing an autonomous taxi with Alice, whom he never met before.
Scott now wishes to reschedule another ride with Alice, but has only one piece of information about her—while driving, Alice mentioned visiting Acre.
Based on relative and partial information (her name Alice and/or the place Acre), the system can find and provided to Scott information about Alice and try to reschedule a ride for him with her.

### Use Case #2—

### Finding an Event (and Scheduling a Drive to it) Based on Relative Tags:

Scott is ride sharing an autonomous taxi with Alice.
Scott now wishes to go to an event that Alice mentioned she plans to attend.
Based on relative and partial information, the system can find and share with Scott information about the event, such as its date, time, place, and attendees, and even schedule a ride to it.

### Use Case #3—

### Buying (Locating) a Product Based on Social Media Relative Tags:

Scott is ride sharing an autonomous taxi with Alice.
Scott remembers that Alice mentioned viewing a post regarding a sale on a new gaming product.
Based on relative and partial information, such as via a social media app or site, the system can obtain and share with Scott a relevant social media link, pate, post or the like regarding the product, information about the product, and/or information or link for purchasing the product.

### Use Case #4—

### Scheduling a Shared Ride Based on Reservation App Relative Data:

Scott wishes to make a social reservation of a taxi with a colleague, client, friend, etc., who has not ridden in an autonomous tax before, or a certain type, such as an autonomous taxi having a sunroof or certain sound system.
Based on relative and partial information in a reservation database (such as a reservation database of an entity maintaining or operating a corresponding service), the system can obtain and provide to Scott information identifying his colleagues, clients, friends, etc., fitting the profile (e.g., never ridden in an autonomous vehicle having the sunroof and sound system).

### Use Case #5—

### Scheduling a Shared Ride Based on Reservation App Relative Data:

Scott & Peter were previously connected based on an inquiry by one of them asked to share a ride with (or a living request for notification about) a person who loves Italian food.
The two shared a taxi based on the dining affinity.
Peter mentioned he takes Yoga classes.
Subsequently, Scott wishes to share a ride again with Peter.
Based on relative and partial information, the system can find a customer account corresponding to Peter and arrange the connection, such as by sending an invitation to Peter on Scott's behalf.

### Use Case #6—

### Scheduling a Shared Ride Based on Reservation App Relative Data:

Scott & Peter were previously connected based on an inquiry by one of them asked to share a ride with (or a living request for notification about) a person who loves Italian food.
The two shared a taxi based on the dining affinity.
Peter was comfortable with Scott infotainment (e.g., music) and climate selections.
Subsequently, Peter wishes to share a ride again with Scott and/or have the vehicle HVAC or infotainment settings set to those settings. The system can store the settings as a preference for Peter, such as via the database module 414.
Based on relative and partial information, the system can find a customer account corresponding to Scott and arrange the connection, such as by sending an invitation to Scott on Peter's behalf, and setting the HVAC or infotainment accordingly.

### Use Case #7—

### Relative Selection of Destination:

A user may ask for information about a destination or other item, place, etc., that a co-passenger mentioned.
The user may ask, for instance, “Please take me to Eastern Market, where Lisa our co-passenger last week went to buy produce.” Based on these tags, or information for searching, the system performs the requested task.
Or a user may ask, “Where did Nick stop for his haircut last week?” and “Can you please provide reviews?” and “If the reviews are good can you make a reservation for me and take me there?”

### Use Case #8:

### Mutual Consent or Opt-in:

Alice and Scott both provide permission to the autonomous ride-share system to explore their social media networks for the service.
Scott is subsequently interested in finding the event that Alice was talking about in their last ride together, and in this way asks or state, “A lady I rode with two days ago was talking about this music festival next week and said she marked it as ‘attending’ in her social media account, and I would like to schedule a ride for that event.”

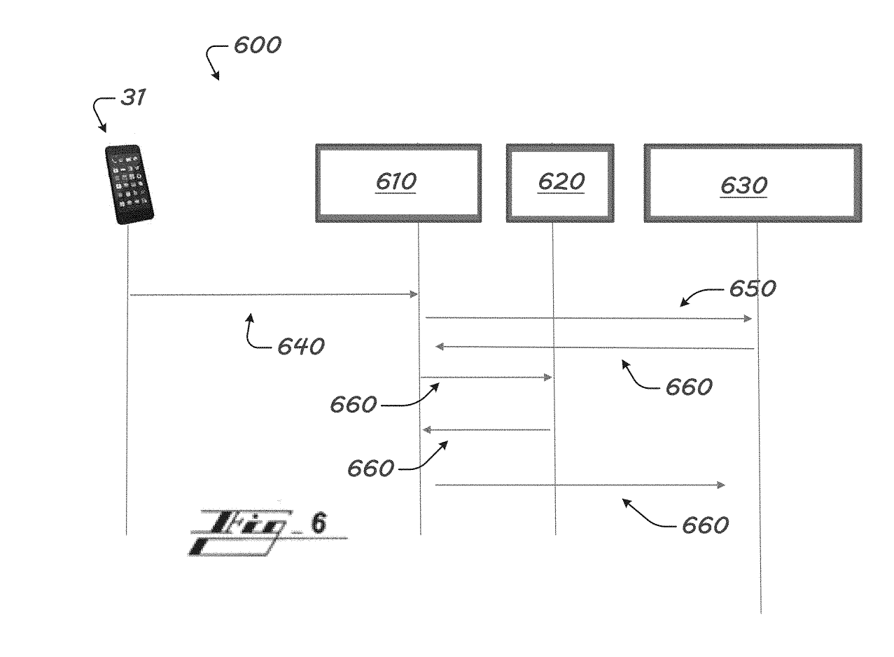

FIG. 6 shows an example operation flow by ladder diagram 600, according to this example. The flow 600 includes:
a portable device 31—e.g., smartphone;
a system-user interface, such as system speech-analysis tool, 610, operated at the portable device or another, local or remote, apparatus—e.g., vehicle 10, server 50;
a social media account 620, site, app, etc.;
a shared-ride reservation system 630

Note: any of these apparatus and systems 31, 610, 620, 630 can be co-located or in two or more various systems or locations.

Flow 600 steps can include:
640: The portable device 31 provides the request or statement to the system-user interface 610;
650: The system-user interface (e.g., speech-analysis tool) converts the request to a text or other filtered result, and passes on to the shared-rides reservation system 630;
660: The shared-rides reservation system 630 returns to the system-user interface 610 one or more names of possible prior passengers that the requesting user could be referring to;
670: The system-user interface 630 searches events or other information cited in a social media-page associated with a determined or likely one prior passenger, via interfacing with the social-media structure 620—social-media site, database, app, server, etc.
680: The social media structure 620 returns to the system-user interface 610 data matching the search, such as event data cited in the determined prior passengers social-media site; and
690/695: The system-user interface 610 advises the user of results (690) and interacts (695) with the shared-rides reservation system 630 to arrange a future ride to the event identified, and possibly with the prior passenger, such as by providing an invitation to the prior passenger.

### VIII. SELECT ADVANTAGES

Many of the benefits and advantages of the present technology are described above. The present section restates some of those and references some others. The benefits described are not exhaustive of the benefits of the present technology.

The present technology enables users of an autonomous shared-ride or taxi service to have a more pleasant shared autonomous ride experience, including post ride, and prior to (e.g., arranging with certain prior co-passengers) future rides.

The technology thus effectively prolongs a duration of the shared autonomous ride experience, potentially from before the passenger enters the vehicle to far after the passenger depart from the car.

The interface can be very natural and intuitive, yielding a more comfortable user-vehicle and/or user-device interaction and overall experience with the vehicle-service, including by using dialogue and high levels of speech interaction, for instance.

The technology in operation enhances driver and/or passenger satisfaction, including comfort, with using automated driving.

People like to refer to one another in a relative manner via technology. Referring to one another in a relative manner requires the system to obtain information regarding the others, which they may not have been comfortable sharing, or have thought to share, during the initial, subject ride, but thought later, or later agreed, that it would be alright to share the information, such as after viewing a social-media page of the requesting user. The system in such ways can provide a mechanism striking a balance between users' natural need to refer relatively to other people and privacy needs.

The technology is expected to lead to increased automated-driving system use. Users are more likely to use or learn about more-advanced autonomous-driving capabilities of the vehicle as well.

A ‘relationship’ between the user(s) and a subject vehicle can be improved—the user will consider the vehicle as more of a trusted tool, assistant, or friend.

The technology can also affect levels of adoption and, related, affect marketing and sales of autonomous-driving-capable vehicles. As users' trust in autonomous-driving systems increases, they are more likely to purchase an autonomous-driving-capable vehicle, purchase another one, or recommend, or model use of, one to others.

Another benefit of system use is that users will not need to invest effort in setting or calibrating automated driver style parameters, as they are set or adjusted automatically by the system, to minimize user stress and therein increase user satisfaction and comfort with the autonomous-driving vehicle and functionality.

### IX. CONCLUSION

Various embodiments of the present disclosure are disclosed herein.

The disclosed embodiments are merely examples that may be embodied in various and alternative forms, and combinations thereof.

The above-described embodiments are merely exemplary illustrations of implementations set forth for a clear understanding of the principles of the disclosure.

References herein to how a feature is arranged can refer to, but are not limited to, how the feature is positioned with respect to other features. References herein to how a feature is configured can refer to, but are not limited to, how the feature is sized, how the feature is shaped, and/or material of the feature. For simplicity, the term configured can be used to refer to both the configuration and arrangement described above in this paragraph.

Directional references are provided herein mostly for ease of description and for simplified description of the example drawings, and the systems described can be implemented in any of a wide variety of orientations. References herein indicating direction are not made in limiting senses. For example, references to upper, lower, top, bottom, or lateral, are not provided to limit the manner in which the technology of the present disclosure can be implemented. While an upper surface may be referenced, for example, the referenced surface can, but need not be, vertically upward, or atop, in a design, manufacturing, or operating reference frame. The surface can in various embodiments be aside or below other components of the system instead, for instance.

Any component described or shown in the figures as a single item can be replaced by multiple such items configured to perform the functions of the single item described. Likewise, any multiple items can be replaced by a single item configured to perform the functions of the multiple items described.

Variations, modifications, and combinations may be made to the above-described embodiments without departing from the scope of the claims. All such variations, modifications, and combinations are included herein by the scope of this disclosure and the following claims.

What is claimed is:

1. A system, for serving a user of a shared-ride service, comprising:
a hardware-based processing unit; and
a non-transitory computer-readable storage component comprising:
a user-input-interface module that, when executed by the hardware-based processing unit, receives, from a tangible machine-user interface, user-input data relating to a user/co-passenger interaction in a shared ride;
a ride-sharing module that, when executed by the hardware-based processing unit, determines, based on the user-input data, an identity or account for a co-passenger who shared the ride with the user; and
an output module that performs an output action based on the identity or account determined.

2. The system of claim 1, wherein:
the shared ride is a present or past shared ride; and
the output action includes scheduling a future shared ride including the user and the co-passenger.

3. The system of claim 1, wherein:
the output module includes an external-communication module that, when executed by the processing unit, performs the output action including communicating with a remote destination based on the user-input data; and
the external-communication module, when executed by the processing unit, communicates with the remote destination to inquire about, reserve, or purchase a product or service.

4. The system of claim 1, wherein the output module includes a customer-notification module that, when executed by the processing unit, initiates communicating a user-notification, for receipt by the user, comprising information relating to said interaction.

5. The system of claim 1, wherein the non-transitory computer-readable storage component comprises a social-media module that is part of the ride-sharing module or in communication with the ride-sharing modules, to when executed by the hardware-based processing unit, obtain, from a social-media resource, social-media data relating to the interaction, for serving the user.

6. The system of claim 1, wherein:
the non-transitory computer-readable storage component comprises a commerce module that, when executed by the hardware-based processing unit, determines, using a commerce-related resource, commerce data related to the interaction; and
the output action is based also on the commerce data.

7. The system of claim 1, wherein:
the non-transitory computer-readable storage component comprises a government-resources module that, when executed by the hardware-based processing unit, determines, using a government resource, government data related to the interaction; and
the output action is based also on the government data.

8. The system of claim 1, wherein:
the shared-ride service comprises an autonomous-vehicle shared-ride service; and
the user-input-interface module, in receiving the user-input data regarding the user/co-passenger interaction, receives user-input data regarding a prior shared autonomous-vehicle ride.

9. The system of claim 1 further comprising the tangible machine-user interface.

10. The system of claim 1 wherein the tangible machine-user interface is a component of an apparatus distinct from the system.

11. The system of claim 1 wherein the apparatus is a portable user device.

12. The system of claim 1 wherein the user-input data comprises a user request for information relating to the user/co-passenger interaction in the prior shared ride.

13. The system of claim 1 wherein:
the non-transitory computer-readable storage component comprises a tag-acquisition module that, when executed by the processing unit, determines one or more relative tags indicated by the user-input data.
the ride-sharing module, when executed to determine the identity or account for the co-passenger, determines the identity or account based on the one or more relative tags determined.

14. The system of claim 1 wherein:
the non-transitory computer-readable storage component comprises a tag-acquisition module that, when executed by the processing unit, determines one or more relative tags indicated by the user-input data;
the non-transitory computer-readable storage component comprises at least one tag-using module selected from a group consisting of: (a) a social-media module, (b) a commerce module, and (c) a government-resources module;
the tag-using module, when executed by the processing unit, determines tag-based results using the one or more relative tags; and
the output action performed is based on the tag-based results.

15. A system, for serving a user of a shared-ride service, comprising:
a hardware-based processing unit; and
a non-transitory computer-readable storage component comprising:
a user-input-interface module that, when executed by the hardware-based processing unit, receives, from a tangible machine-user interface, user-input data relating to a user/co-passenger interaction in a shared ride;
a commerce module that, when executed by the hardware-based processing unit, determines, based on the user-input data, a service or product indicated in the user/co-passenger interaction; and
an output module that performs an output action based on the service or product determined.

16. The system of claim 15 wherein the output action includes recommending to the user, sending an inquiry about, reserving, ordering, or purchasing the service or product determined.

17. The system of claim 15 wherein the commerce module, when executed by the hardware-based processing unit, determines the service or product based on co-passenger data indicating an identity or account of the co-passenger.

18. The system of claim 15 wherein the storage component comprises a social-media module that, when executed by the processing unit, communicates with a social-media resource to obtain social-media data relating to at least one of the interaction, service, and product.

19. The system of claim 15 wherein the storage component comprises a government-resources module that, when executed by the processing unit, communicates with a government resource to obtain government-resource data relating to at least one of the interaction, service, and/or product.

20. A system, for serving a user of a shared-ride service, comprising:
a hardware-based processing unit; and
a non-transitory computer-readable storage component comprising:
a user-input-interface module that, when executed by the hardware-based processing unit, receives, from a tangible machine-user interface, user-input data relating to a user/co-passenger interaction in a shared ride;
a social-media module that, when executed by the hardware-based processing unit, accesses a social-media resource to, based on the user-input data, determine at least one of:
an identity of the co-passenger;
an account of the co-passenger;
a product indicated by the co-passenger or the user in the interaction;
a service indicated by the co-passenger or the user in the interaction; and
a schedule of the co-passenger.
